(19) United States
(12) Patent Application Publication
(10) Pub. No.: US 2025/0020604 A1
(43) Pub. Date: Jan. 16, 2025

(54) PHOTOELECTRON EMISSION MICROSCOPE

(71) Applicant: Hitachi High-Tech Corporation, Tokyo (JP)

(72) Inventors: Momoyo ENYAMA, Tokyo (JP); Akira IKEGAMI, Tokyo (JP); Takeshi MORIMOTO, Tokyo (JP); Yuta KAWAMOTO, Tokyo (JP)

(21) Appl. No.: 18/668,327

(22) Filed: May 20, 2024

(30) Foreign Application Priority Data
Jul. 14, 2023 (JP) 2023-116148

(51) Int. Cl. G01N 23/227

(52) U.S. Cl. CPC G01N 23/227; G01N 2223/306; G01N 2223/404

(57) ABSTRACT

Provided is a photoelectron emission microscope that facilitates acquisition of a high-contrast photoelectron image. A photoelectron emission microscope starts irradiation of a pulsed electron beam 13 performed by an irradiation electron optical system 10 in a manner of overlapping excitation light after predetermined time has elapsed since start of irradiation of a sample 4 with excitation light 2 performed by an excitation optical system 1, and starts capturing a photoelectron image performed by a camera 6 at the time of the start of the irradiation of the pulsed electron beam performed by the irradiation electron optical system or thereafter.

### CROSS-REFERENCE TO RELATED APPLICATION

This application claims priority to Japanese Patent Application No. 2023-116148 filed on Jul. 14, 2023, the entire contents of which are incorporated by reference herein.

### TECHNICAL FIELD

The present invention relates to a photoelectron emission microscope.

### BACKGROUND ART

A photoelectron emission microscope (PEEM) is an apparatus that forms an image by using photoelectrons generated by irradiating a surface of a sample with ultraviolet light or X-rays (excitation light), and can obtain a photoelectron image having contrast caused by a surface structure of the sample.

Patent Literature 1 relates to a photoemission electron microscope, and discloses irradiating a surface of a sample with an electron beam for neutralizing charge in order to prevent charging of the surface of the sample generated when observing an insulator sample.

### CITATION LIST

### Patent Literature

Patent Literature 1: JP2007-165155A.

### SUMMARY OF INVENTION

### Technical Problem

As shown in Patent Literature 1, when observing a sample including an insulator by the photoelectron emission microscope, charging of the sample progresses. As a result of studies performed by inventors, when the sample has a structure including the insulator, contrast of an obtained photoelectron image changes depending on a charged situation of the sample, and the photoelectron image in a state where the charging is prevented does not necessarily represent the structure of the sample with high contrast. In order to obtain a photoelectron image having desired contrast, it is necessary to set the sample in a predetermined charged state, and continuously maintain the charged state during an imaging period of a camera.

### Solution to Problem

A photoelectron emission microscope according to an embodiment of the invention includes: an excitation optical system configured to irradiate a sample with excitation light; a camera configured to capture a photoelectron image by a photoelectron emitted from the sample irradiated with the excitation light; an image formation electron optical system including an objective lens configured to focus the photoelectron on a detection surface of the camera; an irradiation electron optical system configured to irradiate the sample with a pulsed electron beam; and a control unit, in which the control unit controls to start irradiation of the pulsed electron beam performed by the irradiation electron optical system in a manner of overlapping the excitation light after predetermined time has elapsed since start of irradiation of the excitation light performed by the excitation optical system, and controls to start capturing the photoelectron image performed by the camera at the time of the start of the irradiation of the pulsed electron beam performed by the irradiation electron optical system or thereafter.

### Advantageous Effects of Invention

Provided is a photoelectron emission microscope that facilitates acquisition of a high-contrast photoelectron image. Other objects and novel features will become apparent from description of the present specification and the accompanying drawings.

### BRIEF DESCRIPTION OF DRAWINGS

FIG. 1 is a configuration example of a photoelectron emission microscope.

FIG. 2 is a diagram schematically showing a state where a sample is irradiated with excitation light and a pulsed electron beam.

FIG. 3A is a diagram illustrating a principle of the present embodiment.

FIG. 3B is a diagram illustrating the principle of the present embodiment.

FIG. 3C is a diagram illustrating the principle of the present embodiment.

FIG. 4 is a diagram showing extracted parts of an excitation optical system, an image formation electron optical system, and an irradiation electron optical system of the photoelectron emission microscope.

FIG. 5 is a time chart of a control signal for acquiring a photoelectron

FIG. 6 is an example of a recipe setting screen.

### DESCRIPTION OF EMBODIMENTS

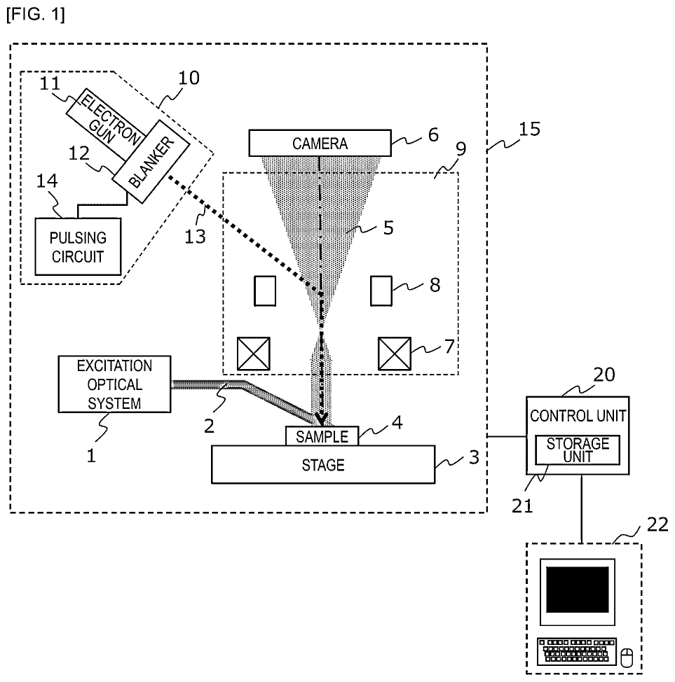

FIG. 1 shows a PEEM that obtains an image by photoelectrons (photoelectron image) generated by irradiating a surface of a sample with excitation light such as laser light or X-rays. An apparatus main body 15 includes, as a main configuration thereof, a stage 3 on which a sample 4 is placed, an excitation optical system 1 that irradiates the sample 4 with excitation light 2, an irradiation electron optical system 10 that irradiates the sample 4 with a pulsed electron beam 13, a camera 6 that captures a photoelectron image, and an image formation electron optical system 9 that forms a photoelectron image on the camera 6. The excitation optical system 1 may include an optical element such as a lens or a mirror in addition to an excitation light source that generates the excitation light 2. The irradiation electron optical system 10 includes an electron gun 11 that emits an electron beam, a blanker 12 that pulses the electron beam emitted from the electron gun 11, and a pulsing circuit 14 that controls the blanker 12.

Photoelectrons 5 generated by irradiating the sample 4 with the excitation light 2 are focused on a detection surface of the camera 6 by an objective lens 7 of the image formation electron optical system 9. In FIG. 1, the objective lens 7 and a beam separator 8 are shown as elements constituting the image formation electron optical system 9, but one-or-more-stage electron lenses and other electron optical elements are provided. Here, the beam separator 8 causes the pulsed electron beam 13 from the irradiation electron optical system 10 to deflect so as to travel toward the sample 4, and causes the photoelectrons 5 generated from the sample 4 to travel to the camera 6. Such a beam separator can be implemented by, for example, a Wien filter or a magnetic field sector. The camera 6 may detect and image the photoelectrons themselves, or may include a scintillator, convert the electrons into light once by the scintillator, and detect and image the converted light.

The apparatus main body 15 is connected to a control unit 20. The control unit 20 receives an instruction from a user input from a graphical user interface (GUI) device 22, controls the apparatus main body 15, and performs image processing on a photoelectron image captured by the camera 6. The control unit 20 includes a storage unit 21, and control parameters of the apparatus main body 15 and the photoelectron image are stored in the storage unit 21.

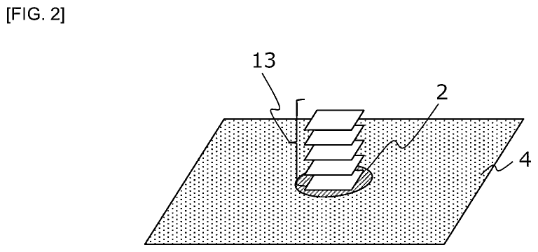

FIG. 2 schematically shows a state where the sample 4 is irradiated with the excitation light 2 and the pulsed electron beam 13. A field of view of the PEEM is determined by an irradiation range of the excitation light 2, and a diameter thereof has a size of about several hundreds of micrometers. The irradiation electron optical system 10 radiates the pulsed electron beam 13 according to the irradiation range of the excitation light 2. That is, control is performed such that irradiation positions of the excitation light 2 and the pulsed electron beam 13 are matched, and irradiation ranges thereof have the same size. In order to radiate such a planar pulsed electron beam 13, the irradiation electron optical system 10 may include a lens that converts the electron beam into a parallel beam upstream of the beam separator 8. In the configuration in FIG. 1, since the pulsed electron beam 13 receives effects of the objective lens 7, it is difficult to convert the pulsed electron beam 13 into a completely parallel beam, but intensity of the pulsed electron beam 13 in an irradiation region may be controlled to be as uniform as possible. Further, the irradiation region of the pulsed electron beam 13 is rectangular in FIG. 2, but is not limited to the shape, and may be circular, elliptical, or the like. The shape of the irradiation region is determined by an opening shape of an aperture provided in the irradiation electron optical system 10. A pulse interval of the pulsed electron beam 13 is assumed to be on an order of nanoseconds to microseconds.

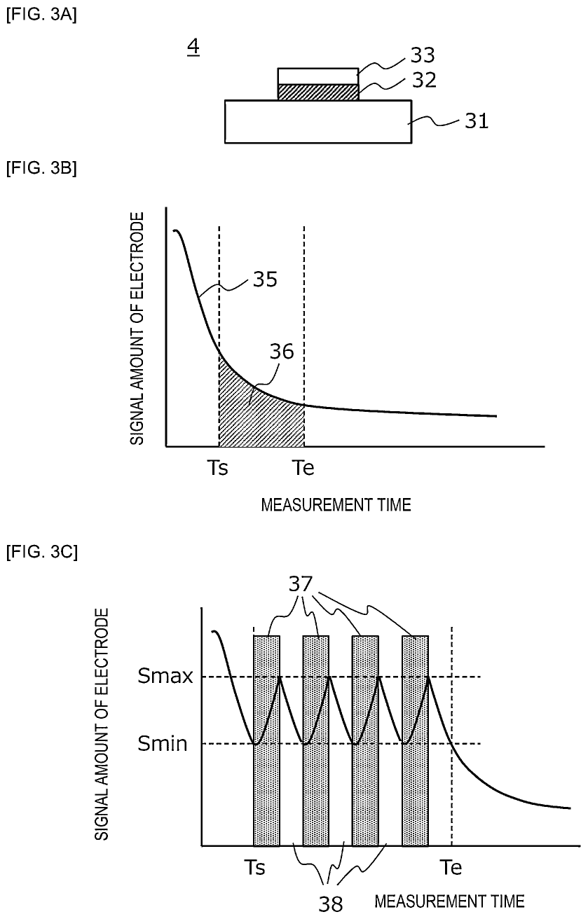

A principle of the present embodiment will be described with reference to FIGS. 3A to 3C. As shown in FIG. 3A, the sample 4 has, for example, a layer structure in which an electrode 33 is provided on a silicon (Si) substrate 31 via an insulator 32, and a photoelectron image of such a sample is acquired. At this time, a generation amount (signal amount) of the photoelectrons 5 from the electrode 33 decreases according to measurement time as shown in FIG. 3B. This is because the electrode 33 is insulated from the substrate 31 by the insulator 32, and there is no supply source of electric charges to the electrode 33, and therefore a charge amount decreases due to emission of the photoelectrons, and an amount of emitted photoelectrons also attenuates over time.

As a result, brightness of the electrode 33 in a photoelectron image is determined according to an area of a region 36 surrounded by an attenuation waveform 35 when imaging time of the camera 6 is between Ts and Te. On the other hand, since a region of the substrate 31 not irradiated with the excitation light 2 serves as a supply source of the electric charges, the brightness of the substrate 31 in the photoelectron image almost does not change regardless of measurement time. Therefore, contrast of the photoelectron image is changed by setting of the imaging time of the camera 6. Therefore, for the sample 4 having the structure as shown in FIG. 3A, it is necessary to set optimum imaging time (imaging start time Ts and imaging end time Te) of the camera 6 to obtain a high-contrast photoelectron image. However, particularly, a rate of attenuation of the signal amount of the electrode 33 is also high at a stage where not much time has elapsed since start of irradiation with the excitation light 2, and a control deviation has a large influence on the contrast of the photoelectron image. When enough time has elapsed since the start of the irradiation with the excitation light 2, the rate of attenuation of the signal amount of the electrode is also low, but it takes a long time to acquire the photoelectron image due to the signal amount decreases, and there is no guarantee that the imaging time of the camera 6 set as described above gives optimum contrast.

Therefore, in the present embodiment, the pulsed electron beam 13 is radiated overlapping the excitation light 2. A time period 37 shown in FIG. 3C is a time period in which one pulse of the pulsed electron beam 13 is radiated to the sample 4. In the time period 37, when the electric charges are supplied to the electrode 33, the charge amount is increased. As a result, the amount of the photoelectrons emitted from the electrode 33 is increased. On the other hand, in the time period 38 in which the electron beam is not radiated, the amount of the photoelectrons emitted from the electrode 33 is decreased. As a result, for example, as shown in FIG. 3C, the imaging time of the camera 6 and a set charged state of the sample between Ts to Te can be controlled, and a change in the signal amount of the electrode can be kept in a range of Smin or more and Smax or less. As described above, in the present embodiment, the pulsed electron beam 13 is radiated overlapping the excitation light 2, and various control parameters of the pulsed electron beam 13, the camera 6, and the like are controlled, and thus a photoelectron image having contrast optimum for observation of the sample 4 can be easily obtained.

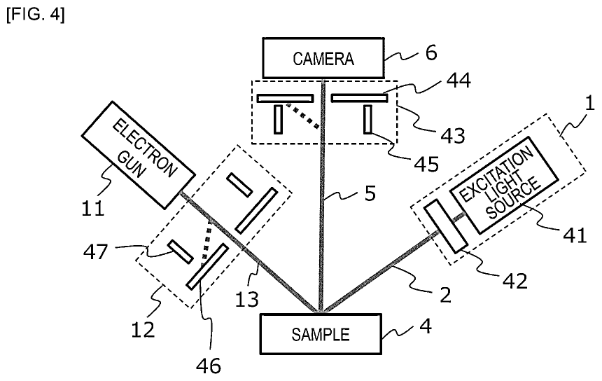

Hereinafter, a method for acquiring a photoelectron image according to the present embodiment will be described. FIG. 4 shows extracted parts of the excitation optical system 1, the camera 6, the image formation electron optical system 9, and the irradiation electron optical system 10 of the photoelectron emission microscope according to the present embodiment. The excitation light source 41 and a shutter 42 are shown as the excitation optical system 1. In order to stabilize the excitation light 2 to continuously radiate the sample 4, it is not desirable to turn on and off the excitation light source 41 itself. Therefore, the shutter 42 is provided to control irradiation and non-irradiation of the sample 4 with the excitation light 2. The shutter 42 may be one made of a mechanical mechanism, or may be one that electrically controls optical crystal. Further, the electron gun 11 and the blanker 12 are shown as the irradiation electron optical system 10. The blanker 12 includes an aperture 46 and a deflector 47. The deflector 47 controls passage and non-passage of the electron beam from the electron gun 11 through the aperture 46, and thus the electron beam is pulsed.

A blanker 43 that pulses the photoelectrons 5 incident on the camera 6 is shown as the image formation electron optical system 9. The blanker 43 includes an aperture 44 and a deflector 45, and pulses the photoelectrons 5 similarly to the blanker 12. A reason why the blanker 43 is provided in the image formation electron optical system 9 will be described with reference to FIG. 3C. As described above, when the sample 4 is irradiated with the electron beam in the time period 37, a signal amount of the photoelectrons is increased, but at this time, secondary electrons are also generated when the sample 4 is irradiated with the electron beam. Since there is not much difference in energy between the photoelectrons and the secondary electrons, it is difficult to separate the photoelectrons from the secondary electrons in the image formation electron optical system 9, and the secondary electrons are actually detected as signal electrons in addition to the photoelectrons in the time period 37. Therefore, the blanker 43 is provided in the image formation electron optical system 9 shown in FIG. 4, and incidence of the electrons on the camera 6 is blocked in the time period 37. Accordingly, noise caused by irradiation of the pulsed electron beam 13 can be prevented. When a signal amount of the secondary electrons can be ignored as compared with the signal amount of the photoelectrons in the time period 37, it is also possible to eliminate blanking of the photoelectrons performed by the blanker 43.

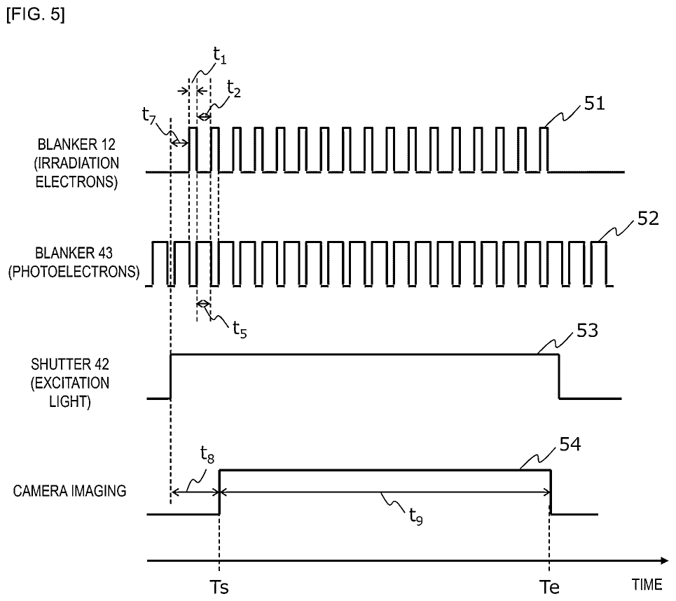

FIG. 5 is a time chart of control signals for acquiring a photoelectron image in the photoelectron emission microscope including the optical system shown in FIG. 4. A control signal 51 is a control signal of the blanker 12 that turns on and off irradiation electrons. A control signal 52 is a control signal of the blanker 43 that turns on and off the photoelectrons. A control signal 53 is a control signal of the shutter 42 that turns on and off the excitation light. A control signal 54 is a control signal of the camera 6 that captures a photoelectron image.

The control signal 51 is a rectangular wave having a pulse width t₁ and a pulse interval t₂. In the example, it is assumed that when a high level of the control signal 51 is input to the blanker 12, the sample 4 is irradiated with the electron beam, and when a low level is input to the blanker 12, the electron beam is blocked. Further, after time t₇ has elapsed since the shutter 42 is turned on and the sample 4 begins to be irradiated with the excitation light 2, irradiation of the sample 4 with the pulsed electron beam 13 is started. After the time t₇ has elapsed, the electrode 33 is in a predetermined charged state. Thereafter, the electron beam is radiated overlapping the excitation light 2 at a timing of the control signal 51, and thus the charged state of the electrode 33 is maintained in a similar state (see FIG. 3C).

The control signal 52 is a rectangular wave having a pulse width t₅ controlled in synchronization with the control signal 51. Similar to the control signal 51, it is assumed that when a high level of the control signal 52 is input to the blanker 43, the photoelectrons 5 are incident on the camera 6, and when a low level is input to the blanker 43, the photoelectrons are blocked. Therefore, in order to prevent incidence of the secondary electrons on the camera 6, in a period in which the control signal 51 is at a high level, the control signal 51 and the control signal 52 are synchronously controlled such that the control signal 52 is always at a low level. In the example, the example of the pulse interval t₂=the pulse width t₅ is shown, but the invention is not limited thereto, and the pulse interval t₂>the pulse width t₅ may be adopted.

Camera imaging is started after time t₈ has elapsed since the shutter 42 is turned on and the sample 4 begins to be irradiated with the excitation light 2. When a relationship of delay time t₈>delay time t₇ is satisfied, the electrode 33 is controlled in a desired charged state. The camera imaging is started at the imaging start time Ts and ended at the imaging end time Te, and a photoelectron image captured in an integration period t₉(=Te−Ts) is integrated, and thus it is possible to obtain a photoelectron image having desired contrast. Thereafter, the shutter 42 blocks the irradiation of the sample 4 with the excitation light 2.

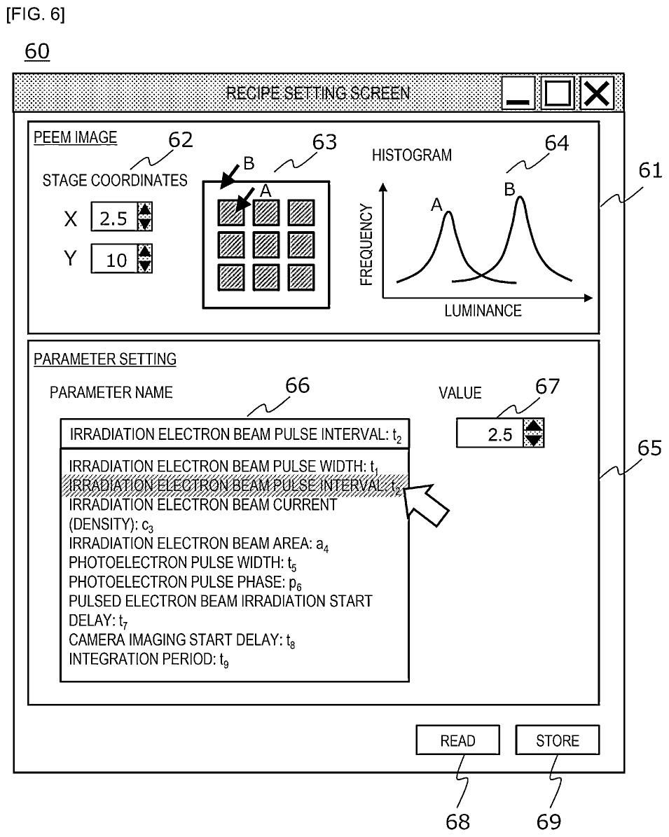

The control unit 20 reads a condition file in which imaging conditions for obtaining the photoelectron image having the desired contrast are set in advance, and stores the condition file in the storage unit 21. When the control unit 20 controls the apparatus main body 15 according to the imaging conditions read in the storage unit 21, the photoelectron image can be obtained. FIG. 6 shows a recipe setting screen for setting the imaging conditions (recipe) for obtaining the photoelectron image having the desired contrast. The recipe setting screen 60 is a display screen displayed on the GUI device 22.

A photoelectron image captured under predetermined imaging conditions is displayed on a photoelectron image display unit 61. A position of the sample 4 for which a photoelectron image is to be acquired is designated by a stage coordinate setting unit 62, and a captured photoelectron image 63 is displayed. For example, when designating a region of the photoelectron image 63, a histogram of luminance of a region where the user wants to emphasize contrast may be displayed. A histogram 64 shows histograms of luminance of a region A and a region B designated on the photoelectron image 63. The user sets control parameters for obtaining the photoelectron image having the desired contrast by a parameter setting unit 65. In the example in FIG. 6, in a parameter name input unit 66, the control parameters can be selected by pulling down. When a control parameter is selected, a value when the photoelectron image 63 is acquired is displayed on a value setting unit 67. The user adjusts the control parameter so as to obtain desired contrast.

The control parameters include, in addition to parameters related to the timings shown in FIG. 5, an irradiation electron beam current (density) c₃, and an irradiation electron beam area a₄ that is an area of the pulsed electron beam 13 on the sample as intensity of the pulsed electron beam 13. Further, a photoelectron pulse phase p₆ indicates a magnitude of a delay in rising of a pulse of the control signal 52 with respect to rising of a pulse of the control signal 51 when the pulse interval t₂>the pulse width t₅.

When the condition file in which the imaging conditions are set in advance is read from outside, a read button 68 is pressed. Further, in order to store the imaging conditions adjusted on the recipe setting screen 60, a storage button 69 is pressed. Accordingly, the imaging conditions adjusted on the recipe setting screen 60 are stored in the storage unit 21.

The method in which the user adjusts the imaging conditions by visual observation has been described above, but when the user designates a region where contrast is desired to be emphasized on the photoelectron image 63, and the control unit 20 feeds back the contrast of the photoelectron image 63 as the imaging conditions, automatic adjustment may be performed. For example, any one of first adjustment in a direction in which a charge amount is increased and second adjustment in a direction in which the charge amount is decreased is performed, adjustment in the same direction is performed when the contrast is improved, and adjustment in different directions is performed when the contrast is decreased, and thus it is possible to improve the contrast of the photoelectron image.

The invention is not limited to the embodiment described above, and includes various modifications. For example, the embodiment described above has been described in detail in order to describe the invention in an easy-to-understand manner, and is not necessarily limited to including all the described configurations. Further, it is possible to add, delete, or replace a part of the configuration of the embodiment with another configuration.

For example, a photoexcited electron source may be used to generate the pulsed electron beam in the irradiation electron optical system 10. The photoexcited electron source is an electron source that generates the electron beam by irradiating a photocathode with the excitation light. It is possible to generate the pulsed electron beam by irradiating the photocathode with pulsed excitation light. When the photoexcited electron source is used, it is also possible to adjust a pulse waveform and intensity of the pulsed electron beam by adjusting a pulse waveform and intensity of the pulsed excitation light. Further, the beam separator is provided to irradiate the sample with the pulsed electron beam in the configuration in FIG. 1, but when there is a margin in a space around the sample, the pulsed electron beam may be radiated obliquely without providing the beam separator.

### Reference Signs List

1: excitation optical system
2: excitation light
3: stage
4: sample
5: photoelectron
6: camera
7: objective lens
8: beam separator
9: image formation electron optical system
10: irradiation electron optical system
11: electron gun
12: blanker
13: pulsed electron beam
14: pulsing circuit
15: apparatus main body
20: control unit
21: storage unit
22: GUI device
31: substrate
32: insulator
33: electrode
35: attenuation waveform
36: region
37, 38: time period
41: excitation light source
42: shutter
43: blanker
44, 46: aperture
45, 47: deflector
51, 52, 53, 54: control signal
60: recipe setting screen
61: photoelectron image display unit
62: stage coordinate setting unit
63: photoelectron image
64: histogram
65: parameter setting unit
66: parameter name input unit
67: value setting unit
68: read button
69: storage button

1. A photoelectron emission microscope comprising:
an excitation optical system configured to irradiate a sample with excitation light;
a camera configured to capture a photoelectron image by a photoelectron emitted from the sample irradiated with the excitation light;
an image formation electron optical system including an objective lens configured to focus the photoelectron on a detection surface of the camera;
an irradiation electron optical system configured to irradiate the sample with a pulsed electron beam; and
a control unit, wherein
the control unit controls to start irradiation of the pulsed electron beam performed by the irradiation electron optical system in a manner of overlapping the excitation light after predetermined time has elapsed since start of irradiation of the excitation light performed by the excitation optical system, and controls to start capturing the photoelectron image performed by the camera at the time of the start of the irradiation of the pulsed electron beam performed by the irradiation electron optical system or thereafter.

2. The photoelectron emission microscope according to claim 1, wherein
the image formation electron optical system includes a beam separator, and
the beam separator causes the pulsed electron beam from the irradiation electron optical system to travel toward the sample, and causes the photoelectron from the sample to travel toward the camera.

3. The photoelectron emission microscope according to claim 1, wherein
the image formation electron optical system includes a blanker configured to pulse a photoelectron incident on the camera, and
during a period in which the sample is irradiated with the electron beam from the irradiation electron optical system, the control unit performs synchronous control such that the blanker blocks incidence of the photoelectron on the camera.

4. The photoelectron emission microscope according to claim 1, wherein
the irradiation electron optical system irradiates the sample with the planar pulsed electron beam.

5. The photoelectron emission microscope according to claim 1, wherein
the control unit includes, as imaging conditions of the photoelectron image, a pulse width, a pulse interval, intensity, and an area on the sample of the pulsed electron beam, delay time from the start of the irradiation of the excitation light to the start of the irradiation of the pulsed electron beam, delay time from the start of the irradiation of the excitation light to the start of the imaging performed by the camera, and imaging time of the camera, and
the imaging conditions are determined based on contrast of the photoelectron image.

6. The photoelectron emission microscope according to claim 3, wherein
the control unit includes, as imaging conditions of the photoelectron image, a pulse width, a pulse interval, intensity, and an area on the sample of the pulsed electron beam, a pulse width of the photoelectron, a pulse phase of the photoelectron, delay time from the start of the irradiation of the excitation light to the start of the irradiation of the pulsed electron beam, delay time from the start of the irradiation of the excitation light to the start of the imaging performed by the camera, and imaging time of the camera, and
the imaging conditions are determined based on contrast of the photoelectron image.

7. A photoelectron emission microscope comprising:
an excitation optical system configured to irradiate a sample with excitation light;
a camera configured to capture a photoelectron image by a photoelectron emitted from the sample irradiated with the excitation light;
an image formation electron optical system including an objective lens configured to focus the photoelectron on a detection surface of the camera;
an irradiation electron optical system configured to irradiate the sample with a pulsed electron beam;
a control unit; and
a GUI device, wherein
the control unit controls to start irradiation of the pulsed electron beam performed by the irradiation electron optical system in a manner of overlapping the excitation light after predetermined time has elapsed since start of irradiation of the excitation light performed by the excitation optical system, and controls to start capturing the photoelectron image performed by the camera at the time of the start of the irradiation of the pulsed electron beam performed by the irradiation electron optical system or thereafter, and
the GUI device displays imaging conditions of the photoelectron image together with the photoelectron image acquired by the camera, and displays a recipe setting screen on which the imaging conditions are adjusted.

8. The photoelectron emission microscope according to claim 7, wherein
the imaging conditions of the photoelectron image include a pulse width, a pulse interval, intensity, and an area on the sample of the pulsed electron beam, delay time from the start of the irradiation of the excitation light to the start of the irradiation of the pulsed electron beam, delay time from the start of the irradiation of the excitation light to the start of the imaging performed by the camera, and imaging time of the camera.

9. The photoelectron emission microscope according to claim 7, wherein
the image formation electron optical system includes a blanker configured to pulse a photoelectron incident on the camera, and
during a period in which the sample is irradiated with the electron beam from the irradiation electron optical system, the control unit performs synchronous control such that the blanker blocks incidence of the photoelectron on the camera.

10. The photoelectron emission microscope according to claim 9, wherein
the imaging conditions of the photoelectron image include a pulse width, a pulse interval, intensity, and an area on the sample of the pulsed electron beam, a pulse width of the photoelectron, a pulse phase of the photoelectron, delay time from the start of the irradiation of the excitation light to the start of the irradiation of the pulsed electron beam, delay time from the start of the irradiation of the excitation light to the start of the imaging performed by the camera, and imaging time of the camera.
